(19) United States
(12) Patent Application Publication
(10) Pub. No.: US 2004/0191026 A1
(43) Pub. Date: Sep. 30, 2004

(54) Method and apparatus for feeding a stacke of metallic sheets into a melting furnace

(76) Inventors: Tero Raitanen, Helsinki (FI); Jukka Saamanen, Espoo (FI); Tom Marttila, Espoo (FI)

Correspondence Address: MORGAN & FINNEGAN, L.L.P., 345 PARK AVENUE, NEW YORK, NY, 10154, US

(21) Appl. No.: 10/250,585

(22) PCT Filed: Jan. 2, 2002
(86) PCT No.: PCT/FI02/00001

(30) Foreign Application Priority Data
Jan. 4, 2001 (FI) 20010013

(51) Int. Cl. B66C 17/08

(52) U.S. Cl. 414/172

(57) ABSTRACT

A method for conveying stacks of metallic sheets, in particular stacks of metallic cathodes, into a melting furnace. The stack of metallic sheets (1) is gripped by a grapple element (10), such as a lifting grapple, which is arranged on a transfer device, and the stack of metallic sheets (1) is transferred into the melting furnace (2) chamber (14), and that at a predetermined height inside the furnace chamber, preferably relatively near the bottom of the furnace and/or melt, the metallic stack (1) is released.

This invention relates to a method for feeding stacks of metal into a melting furnace described in the preamble of claim 1. The invention also relates to the apparatus described in the preamble to claim 5.

Production methods are used in the manufacture of metals where, at certain stages, stacks of metallic sheets are fed into a melting furnace. For instance, these could be stacks of cathodes, such as zinc cathode sheet stacks separated from the permanent cathode by the stripping machine, which are melted in the melting furnace and cast into castings, e.g. into castings easier to transport, such as blocks.

Methods and apparatus are known whereby metallic cathode stacks arranged on a conveyor are dropped straight from the melting furnace feed inlet into the furnace. Metallic cathode stacks dropped thus from relatively high have exposed parts of the furnace, such as the lining and inductors, to being hit and to damage caused by this. In addition, dropping the stacks from a height has harmful effects on the temperature of the melt in the furnace, which should remain stable. These factors have been detrimental to the service life of the furnace parts.

The purpose of this invention is to obtain a method and apparatus that will help avoid the drawbacks of the prior art.

The characteristics of the invention are made apparent in the patent claims.

The method and apparatus of the present invention have many significant advantages. Lowering the stacks of cathodes into the furnace chamber relatively near the bottom of the furnace avoids strong blows to the furnace parts. Furthermore, lowering the cathodes into the melt slowly avoids great changes in temperature. The apparatus of the invention, with which the cathode stacks are lowered into the furnace chamber, avoids the use of complicated actuators with its grapple mechanism structure, so that the grapple is long-lasting and reliable in the conditions prevailing inside the furnace chamber.

There follows a more detailed description of the invention using an example, with reference to the attached drawings, where

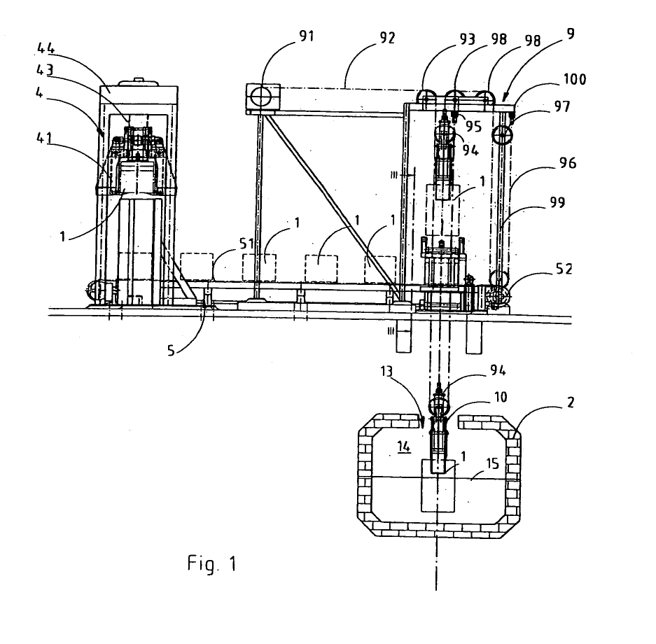

FIG. 1 presents an embodiment of the invention seen from the side,

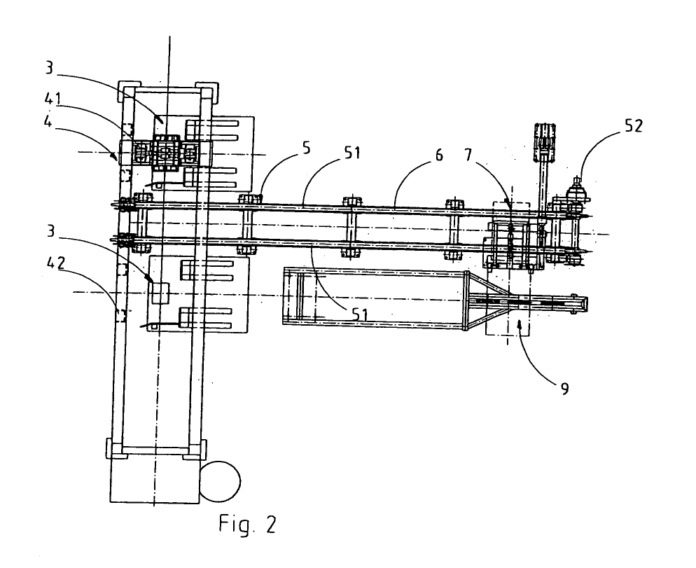

FIG. 2 shows the apparatus in FIG. 1 from above,

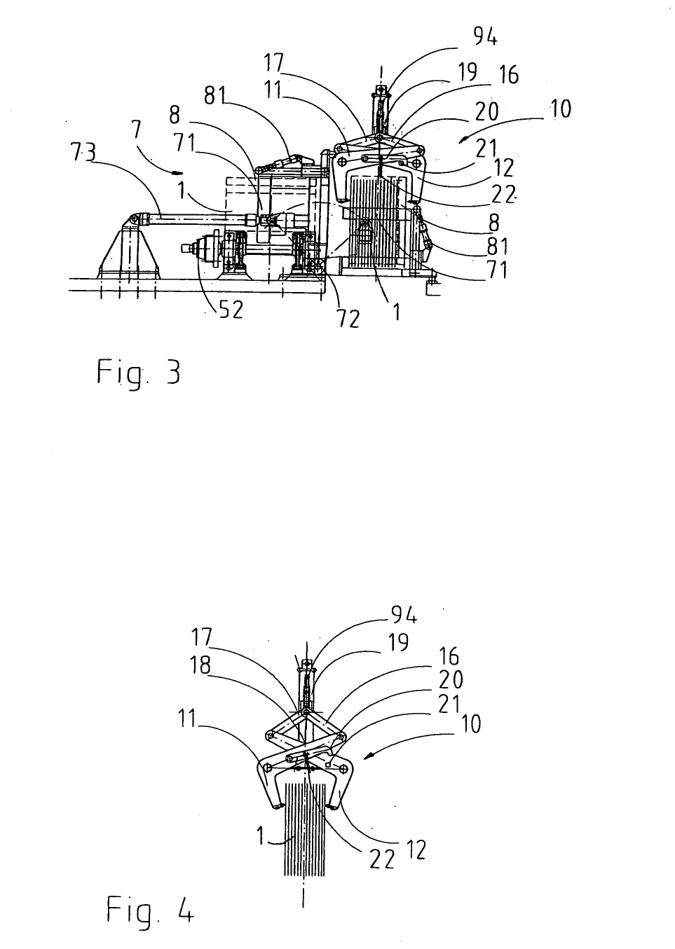

FIG. 3 presents a detailed view of the gripping stage of a metallic sheet stack at the line III-III in FIG. 1, and

FIG. 4 shows the transfer stage of the metallic sheet stack.

The drawings show a certain embodiment of the invention, where metallic sheet stacks 1 are fed into a melting furnace 2. The metallic sheet stacks 1, such as cathode stacks in particular, are shown in FIG. 1 in simplified form. The apparatus shown in the drawings comprises at least one loading station 3, to which the metallic sheets are brought for instance by forklift. At the loading station 3 the metallic sheets are stacked one on top of another into a pile, from which the first transfer device 4, preferably a transfer elevator, separates a dimensioned stack 1 and conveys it to a stack conveyor 5. The stack conveyor 5, for example a chain conveyor, on which the metallic sheet stack is placed on top of continuous chains 6, moves the stack 1 to the turning station 7. At the turning station 7 the stack of sheets is turned from a horizontal position, where the metallic sheets were on top of each other, to a vertical position. The rotation is thus preferably about 90 degrees. The turning device of the turning station 7 also includes a movable back stop 8, with which the stack of sheets 1 is pressed tight. The grapple 10 of a second transfer device 9 grips the vertical stack of sheets 1. The clamping elements 11, 12 of the grapple press against the outer sheets on opposite edges of the stack and lift the stack of sheets from the turning device 7 and transfer the stack I from the feed inlet 13 of the melting furnace 2 into the furnace chamber 14. The stack of sheets is lowered inside the furnace preferably at least partially below the surface of the melt 15, whereupon the grapple 10 opens and the stack is released from the grip of the grapple 10 to remain in the furnace chamber 14. The grapple 10 is preferably arranged to open at a regulated standard height inside the furnace chamber 14. The grapple is raised out of the furnace chamber to take the next stack from the turning device.

In the method of the invention, in order to transfer stacks of metallic sheets, in particular stacks of metallic cathodes, to the melting furnace, the stack of metallic sheets 1 is gripped by a grapple element 10, such as a lifting grapple, which is fixed on a transfer device, and the stack of metallic sheets 1 is moved into the melting furnace 2 chamber 14, and at a predetermined height inside the furnace chamber, preferably relatively near the bottom of the furnace and/or melt, the metallic stack 1 is released. The stack of metallic sheets 1 is gripped by the grapple device 10 by the opposite walls of the stack of sheets. The stack of metallic sheets 1 is turned to a vertical position before the grapple element 10 grips it. The stack of metallic sheets 1 is released by acting on the grapple element 10 with a mechanical arrangement.

The apparatus according to the invention for conveying stacks of metallic sheets 1, in particular metallic cathode stacks, to a melting furnace 2 comprises a lifting device 9 and a grapple device 10 fixed to it and elements arranged on the grapple for the release of the stack of metallic sheets 1 into the chamber 14 of a melting furnace 2 at a predetermined height. The grapple device 10 consists of a grapple frame 18, which is arranged movably on a lifting frame 19, and clamp elements 11, 12 hinged scissor-like to the grapple frame, and attached in a hinged way at the upper ends to the lifting frame 19 by means of support arms 16, 17 so that when the grapple frame 18 moves downwards in relation to the lifting frame 19, the clamp elements 11, 12 move into the clamping position and that when the grapple frame 18 moves upwards with regard to the lifting frame 19, the clamp elements 11, 12 move towards the open position. The grapple frame 18 stop element 96, in particular a stop cable, is set to the grapple 10 connection, which at a certain predetermined point prevents the movement of the grapple frame 18 with the lifting frame 19 when lowering the stack of metallic sheets 1 into the furnace chamber 14, so that the grapple frame in relation to the lifting frame 19 begins to move upwards, whereupon the clamp elements 11, 12 move towards the open position. The grapple device also comprises locking elements 20, 21 for locking the clamp elements 11, 12 at least in the open position and an element 22 for removing the locking of the clamp element. In addition the equipment comprises at least one loading station 3, a feeding device 4 for detaching the stacks of metallic sheets 1 in the loading station at a standard height and for conveying the stacks of sheets to a conveying device 5, a conveying device 5 for transferring the stacks of metallic sheets 1 to the sheet stack turning station 7 and appliances on the turning station for turning the stacks of metallic sheets 1 into an upright position. The stop cable acting as a grapple frame stop element on the grapple device is fixed by its first end to the grapple frame and at the other end to the frame structure 100 and arranged so as to move via at least two bending wheels 97, 98, of which at least one bending wheel 97 is attached movably to its guide 99.

The equipment according to the invention, in particular the transfer device 9, with which the stack of metallic sheets 1 that have been turned upright is moved from the turning device to the furnace 2 comprises therefore a lifting device. The drive mechanism 91 of the lifting device comprises a winding drum and appliances for operating the winding drum as well as a hoist rope 92 or the like, which is preferably a lifting cable. From the winding drum the hoist rope 92 is routed via the first bending wheel 93 and via the second bending wheel 94 on the grapple 10 connection to the fixing point 95 on the frame of the transfer device, to which the hoist rope 93 is attached at one end. Thus using the winding drum of the lifting device the grapple 10 is raised or lowered depending on which direction the winding drum is turned. The mechanism connected to the grapple 10 is described in more detail in FIG. 3. The grapple consists of clamp elements 11, 12, which are attached in scissor-like fashion to turn on the grapple frame 18. Clamp elements 11, 12 are attached in a hinged way at their upper end to support arms 16, 17, which for their part are attached in a hinged way at their upper ends to the lifting frame 19. The grapple frame 18 is attached movably to the lifting frame 19, preferably to move in essence vertically. When the grapple frame 18 is in the lower position, the clamps 11, 12 hold the stack of metallic sheets 1 in the clamped position and correspondingly when the grapple frame 18 is in the upper position, the clamps 11, 12 are in the open position (FIG. 3). In the equipment shown in the drawings there is a stop element 96, typically a stop cable element or the like, preferably a stop cable, arranged on the frame 18 of the grapple 10, which arrests the downward movement of the grapple frame 18 chamber at a certain pre-regulated height in the furnace. Thus the lifting frame 19 may be lowered further in relation to the grapple frame, whereby the clamps 11, 12 are forced by the support arms 16, 17 to move towards the open position. The regulated height can be determined for instance by adjusting the length of the stop cable element 96. In the case illustrated in FIG. 2, a mechanism is arranged on the stop cable element 96 connection, which comprises several bending wheels 97, 98, via which the stop cable 96 is arranged to move. The arrangement consists of one bending wheel 97 arranged to move in guide 99, in which bending wheel stop cable 96 is arranged to move. When the grapple 10 is lowered towards the furnace 2 the bending wheel 97 is raised inside the guide 99. When the bending wheel 97 is at its top position the stop cable element 96 stops the grapple frame 18.

When the clamps 11, 12 have opened sufficiently the locking element 20 arranged on their connection locks the clamps 11, 12 in the open position. In the embodiment shown in the drawings the locking element 20 is a clip element, which is hinged at one end to the first clamp 11 and the clip at the other end is arranged so as to lock onto a counter element 21 arranged on the other clamp 12. In the locked position the locking element 20 also prevents the grapple frame 18 from moving in relation to the lifting frame 19. The locking element 20 opens only when the grapple 10 is lowered to take a new stack 1, as the back stop 22 arranged on the locking element 20 touches the upper part of the stack 1.

A grapple is shown in FIGS. 3 and 4 in two positions. In the open position (FIG. 3) the grapple 10 is taking a stack of sheets 1 from the turning device. In this position the locking element back stop is only just touching the upper surface of the stack, and the locking element has not yet released the clamps. In the other position (FIG. 4) the grapple is shown in the lifting position, when the stack of metallic sheets 1 is between the clamps 11, 12. The lifting device is omitted from FIG. 3 for reasons of clarity.

The equipment described in FIGS. 1 and 2 thus also include the first conveying device 4, preferably a transfer elevator, of which the grapple element 41 separates a dimensioned stack 1 from the pile of metallic sheets at the loading station 3, and conveys it to the stack conveyor 5. The transfer elevator 4 is arranged so as to move along a track 42 transverse to the stack conveyor, where said track extends to the stack conveyor 5 and at least one loading station 3. In the embodiment shown there are two loading stations 3, between which there is a stack conveyor feed end 6. The grapple element 41 is typically equipped to move with lifting elements 43, such as hoist cables. The lifting elements 43 are moved using drive equipment 44, such as a winding drum and its drive mechanism.

The stack conveyor 5 comprises a conveyor element 51, such as at least one chain conveyor, which is arranged to convey the stacks of metallic sheets 1 set upon it to the turning station 7. The conveyor element 51 is moved by a drive mechanism 52, such as a drive wheel.

FIG. 3 also shows the turning device of the sheet stack 1 turning station 7 in more detail. The turning device comprises a frame 71, on which appliances are arranged for supporting the sheet stack at least during the turning movement. In addition, the turning device includes preferably also a movable back stop 8 to press the stack of sheets tighter together at least before the grapple 10 grips the stack 1. The back stop 8 is moved using a back stop drive mechanism 81, such as a compression cylinder. The turning device frame 71 is hinged to turn typically around a shaft 72 that is in the same direction as the stack conveyor 5. The turning device comprises in addition a rotating element 73, typically a compression cylinder. In the drawing the turning device is shown in two positions, the position before turning and the turned position.

It will be clear to experts in the field that the location of different equipment and the directions in which they move or turn vary according to the requirements set by the forms of the application. The method and equipment of the invention are extremely suitable for conveying for example stacks, of metallic cathode sheets, such as stacks of zinc sheets, into a melting furnace.

1. A method for conveying stacks of metallic sheets, into a melting furnace, the method comprising gripping the stack of metallic sheets by a grapple element which is arranged on a transfer device, and transferring the stack of metallic sheets into a melting furnace chamber, and that at a predetermined height inside the furnace chamber releasing the metallic stack by acting on the grapple element with a mechanical arrangement.

2. A method according to claim 1, wherein the stack of metallic sheets is gripped by the grapple device by the opposite walls of the stack of sheets.

3. A method according to claim wherein the stack of metallic sheets is turned to a vertical position before it is gripped by the grapple element.

4. An apparatus for conveying stacks of metallic sheets to a melting furnace wherein the apparatus comprises a lifting device and a grapple device arranged on it and elements arranged on the grapple for the release of the stack of metallic sheets into the chamber of a melting furnace at a predetermined height, the grapple device containing a grapple frame, which is arranged movably on a lifting frame of the grapple, and clamp elements hinged scissor-like onto the grapple frame, and attached in a hinged way at the upper ends to the lifting frame by support arms so that when the grapple frame moves downwards with regard to the lifting frame, the clamp elements move into a clamping position and that when the grapple frame moves upwards with regard to the lifting frame, the clamp elements move towards an open position.

5. An apparatus according to claim 4, wherein the grapple frame stop element is arranged onto the grapple connection, which at a certain predetermined point prevents the movement of the grapple frame with the lifting frame when lowering the stack of metallic sheets into the furnace chamber, so that the grapple frame in relation to the lifting frame begins to move upwards, whereupon the clamp elements move towards the open position.

6. An apparatus according to claim 4, wherein the grapple device also comprises locking elements for locking the clamp elements at least in the open position and an element for removing the clamp element lock.

7. An apparatus according to claim 4, wherein the apparatus comprises at least one loading station, a feeding device for detaching the stacks of metallic sheets from the loading station at a standard height and for conveying the stacks of sheets to a conveying device, a conveying device for transferring the stacks of metallic sheets to sheet stack turning station and appliances on the turning station for turning the stacks of metallic sheets into an upright position.

8. An apparatus according to claim 4, wherein the stop cable acting as a grapple frame stop element on the grapple device is fixed by the first end to the grapple frame and at the other end to the frame structure and arranged so as to move via at least two bending wheels, of which at least one bending wheel is arranged so as to move in its guide.

9. A method according to claim 1, wherein the grapple element is a lifting grapple.

10. A method according to claim 1, wherein the metallic stack is released relatively near the bottom of the furnace and/or melt.
